(19) United States
(12) Patent Application Publication
(10) Pub. No.: US 2005/0185568 A1
(43) Pub. Date: Aug. 25, 2005

(54) Storage device

(76) Inventor: Robert J. Davidson, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/784,622

(22) Filed: Feb. 23, 2004

(51) Int. Cl. G11B 9/00

(52) U.S. Cl. 369/126

(57) ABSTRACT

The present invention provides a storage device. The storage device comprises a field emitter, a storage medium having a storage area being in one of at least three states to represent information stored at the storage area, and a read circuit for sensing the state of the storage area and providing an output signal representative of the sensed status.

### BACKGROUND

For decades, researchers have been working to increase storage density and reduce storage cost of information storage devices such as magnetic hard-drives, optical drives, and semiconductor random access memory. However, increasing the storage density is becoming increasingly difficult. Conventional technologies appear to be approaching fundamental limits on storage density. For instance, information storage based on conventional magnetic recording is rapidly approaching fundamental physical limits such as the superparamagnetic limit, below which a magnetic bit is not stable at room temperature.

Information storage devices that do not face these fundamental limits are being researched and developed. One such device, an atomic resolution storage device, includes multiple electron emitters having electron emission surfaces that are proximate a storage medium. During a write operation, an electron emitter changes the state of a submicron-sized storage area on the storage medium by bombarding the storage area with a relatively high intensity electron beam having an appropriate pulse shape and amplitude. The storage medium is either in a crystalline state or an amorphous state. By changing the state of the storage area, a bit is written to the storage area.

During a read operation, an electron emitter bombards the storage area with an electron beam. The electron beam used for read operations can be of a relatively low intensity so as not to change the state of the storage area.

### SUMMARY

One aspect of the present invention provides a storage device. The storage device comprises a field emitter, a storage medium having a storage area being in one of at least three states to represent information stored at the storage area, and a read circuit for sensing the state of the storage area and providing an output signal representative of the sensed state.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is a diagram illustrating one embodiment of a cross section of a side view of a storage device.

FIG. 2 is a block diagram illustrating one embodiment of a storage device according to the present invention.

FIG. 3 is a diagram illustrating one embodiment of writing and reading a plurality of states at memory locations in a storage device according to the present invention.

FIG. 4 is a diagram illustrating another embodiment of reading a plurality of states at memory locations in a storage device according to the present invention.

FIG. 5 is a bar chart illustrating the magnitude of an output signal from a read circuit for a plurality of states at memory locations in a storage device according to the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

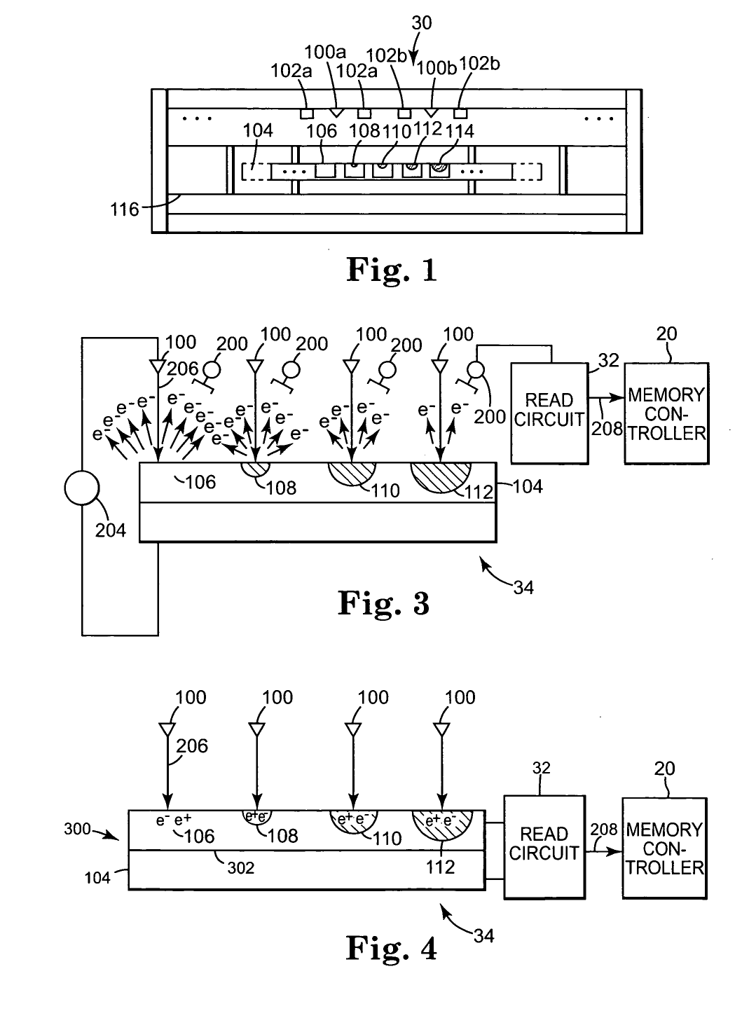

FIG. 1 is a diagram illustrating one embodiment of a cross section of a side view of a storage device 30. Storage device 30 is known as an “atomic resolution storage (ARS) device” and includes a plurality of field emitters 100a-100b and their corresponding gates 102a-102b, a storage medium 104, including a plurality of storage areas 106-114, and a micromover 116. Emitters 100a-100b are proximate storage medium 104. Storage medium 104 is coupled to micromover 116.

Micromover 116 moves storage medium 104 relative to field emitters 100a-100b. In one embodiment, field emitters 100a-100b remain stationary while storage medium 104 is moved. In another embodiment, storage medium 104 remains stationary while field emitters 100a-100b are moved.

In one embodiment, field emitters 100a-100b are point-emitters with very sharp points; each may have a radius of curvature of about one nanometer to hundreds of nanometers. During operation, a preselected potential difference is applied between a field emitter and its corresponding gage, such as between the emitter 100a and its circular gate 102a surrounding it. Due to the sharp point of the emitter, an electron beam current is extracted from the emitter towards the storage area. Depending on the distance between the emitters and storage medium 106, the type of emitters, and the spot size (bit size) required, one might need electron optics to focus the electron beams. A voltage may also be applied to storage medium 104 to either accelerate or decelerate the field-emitted electron is or to aid in focusing the field-emitted electrons. In one embodiment the storage medium is kept in partial vacuum, such as at least 10⁻⁵ torr.

Storage medium 104 comprises individual storage areas 106-114. Each storage area 106-114 can be altered to store one of a number of different states representing different values or bits of information. Each electron emitter 100a-100b generates an electron beam current of varying power density for bombarding a storage area 106-114. Each storage area 106-114 is written to or set to one of a plurality of structural states by varying the power density of the electron beam current. Each storage area 106-114 is set to a crystalline state, an amorphous state or any state in between a crystalline state and an amorphous state. A state between a crystalline state and an amorphous state is referred to as a partially amorphous state.

The number of states each storage area 106-114 can be set to, and hence the number of values each storage area 106-114 can represent, is defined by the precision with which the states can be set by electron bombardment and read by a memory controller and read circuit. In one embodiment, each storage area 106-114 can be set to one of three states, including a crystalline state, an amorphous state, and a partially amorphous state substantially halfway between the crystalline state and the amorphous state. In other embodiments, each storage area 106-114 can be set to one of four, five, or more different states.

In one embodiment, storage area 106 has not been altered by electron bombardment and represents the value “0.” Storage area 108 has been altered by electron bombardment more than storage area 106, but less than storage area 110, and represents the value “1.” Storage area 110 has been altered by electron bombardment more than storage area 108, but less than storage area 112, and represents the value “2.” Storage area 112 has been altered by electron bombardment more than storage area 110, but less than storage area 114, and represents the value “3.” Storage area 114 has been altered by electron bombardment more than storage area 112, and represents the value “4.” Each storage area 106-114 has been set to one of five different states. In other embodiments, each storage area 106-114 can be electron bombarded by alternate power densities depending on a desired application. Similarly, the different states can represent other values. Also in other embodiments, varying numbers of states can be employed. In yet other embodiments, some storage areas may be set by electron bombardment and other storage areas may not be set by electron bombardment, depending on a desired application.

During operation of storage device 30, a predetermined potential difference is applied between field emitter 100a-100b and corresponding gate 102a-102b that extracts an electron beam current from emitter 100a-100b towards storage area 106-114 on storage medium 104. Writing of data from emitter 100a-100b to storage area 106-114 is accomplished by temporarily increasing the power density of the electron beam current to modify the structural state of the surface of storage area 106-114. Reading data from storage area 106-114 is accomplished by detecting the effect of storage area 106-114 on the electron beam of emitter 100a-100b, or the effect of the electron beam on storage area 106-114.

For example, a predetermined potential difference is applied between field emitter 100a and corresponding gate 102a that extracts an electron beam from emitter 100a towards storage area 108. The power density of the electron beam current from field emitter 100a is temporarily increased to modify the structural state of the surface of storage area 108. Reading data from storage area 108 is accomplished by detecting the effect of storage area 108 on the electron beam of emitter 100a, or the effect of the electron beam on storage area 108.

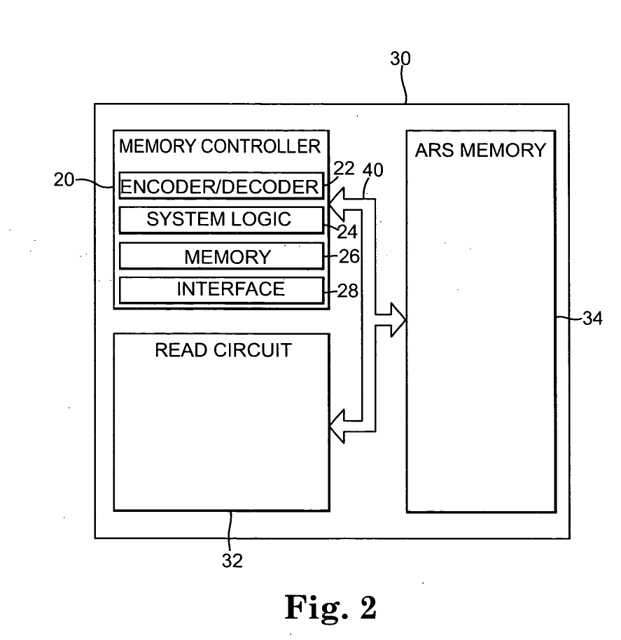

FIG. 2 is a block diagram illustrating one embodiment of storage device 30. Storage device 30 includes a memory controller 20, a read circuit 32, a memory 34, and a communication link 40. Data passes between memory controller 20, read circuit 32, and memory 34 through communication link 40.

Memory controller 20 comprises hardware, software, or a combination of hardware and software and includes an encoder/decoder 22, system logic 24, a memory 26, and an interface 28. Memory controller 20 operates to pass data between memory 34 and a host or external device (not shown) through interface 28.

Encoder/decoder 22 translates data between an external device and memory 34. The encoder portion of encoder/decoder 22 encodes data received from an external device into one of at least three different states (crystalline, amorphous, and partially amorphous) for storage in a storage area in memory 34. In one embodiment, the encoder portion of encoder/decoder 22 encodes data received from an external device into multiple partially amorphous states. The decoder portion of encoder/decoder 22 decodes data stored in memory 34 from at least three different states (crystalline, amorphous, and partially amorphous) to data usable by the external device. In one embodiment, the decoder portion of encoder/decoder 22 decodes data stored in memory 34 from multiple partially amorphous states to data usable by the external device.

Because many computer systems can only process data in two logic states, i.e. logic “0” and logic “1,” encoder/decoder 22 translates between the bi-state logic of the external device and the multi-state logic storage provided by memory 34. In addition, encoder/decoder 22 translates data addresses received from the external device to addresses of physical storage locations in memory 34. Encoder/decoder 22 performs this translation to addresses of physical storage locations using a spare table stored in memory 26.

System logic 24 comprises logic to operate memory controller 20 and comprises a combination of both hardware and software. System logic 24 includes circuits to aid in reading and writing data to memory 34. In addition, system logic 24 includes circuits required to interconnect and control all the components of memory controller 20, including encoder/decoder 22, memory 26, and interface 28. In one embodiment, system logic 24 functions as a microprocessor.

Memory 26 comprises any type of memory including volatile and non-volatile memory. For example, memory 26 can include dynamic random access memory (DRAM), static random access memory (SRAM), Flash memory, etc. Memory 26 is used to store data and/or instructions used in the operation of storage device 30, such as an operating system. Memory 26 also stores error correction and mapping information. In one embodiment, memory 26 includes a spare table containing replacement addresses for unusable memory locations in memory 34.

Interface 28 communicates with an external device to pass data between storage device 30 and the external device. Interface 28 provides mechanical, electrical, or both mechanical and electrical coupling to an external device, such as a host. In one embodiment, interface 28 includes pins extending from a chip adapted for mounting onto a printed circuit board (PCB). In another embodiment, interface 28 includes a male or female connector adapted for coupling to a female or male connector respectively. In addition, interface 28 is permanently or removably coupled to an external device.

Read circuit 32 provides an output signal to memory controller 20 that represents the state of a storage area in memory 34. In one embodiment, read circuit 32 reads the state of a storage area by measuring the effect of secondary and/or backscattered electrons when an electron beam is applied to the storage area. In another embodiment, the state of the storage area is read by measuring the current through the storage area when an electron beam is applied to the storage area. Read circuit 32 is discussed in detail in reference to FIGS. 3 and 4. In one embodiment, memory controller 20 comprises at least a portion of read circuit 32.

Memory 34 is an ARS memory and includes a plurality of field emitters, such as field emitters 100a and 100b, and their corresponding gates, such as gates 102a and 102b, a storage medium 104, including a plurality of storage areas, such as 106-114, and a micromover 116. The emitters, such as 100a and 100b, are proximate storage medium 104. Storage medium 104 is coupled to micromover 116.

In operation, storage device 30 receives a request from a host or external device through interface 28. The request is either a memory read request or a memory write request. System logic 24 facilitates reading or writing data to memory 34.

In the event of a memory read request, encoder/decoder 22 translates the referenced read address to an address of a physical storage location, using a spare table in memory 26 if necessary, and retrieves the data from memory 34 through read circuit 32 and communication link 40. Encoder/decoder 22 decodes the data retrieved, which can be tri-state (crystalline, amorphous, and partially amorphous) or multi-state (crystalline, amorphous, and two or more different partially amorphous states), to data in the form required by the requesting device.

In the event of a memory write request, encoder/decoder 22 translates the referenced write address to an address of a physical storage location, using a spare table in memory 26 if necessary. Encoder/decoder 22 encodes the data for storage in memory 34 into one of at least three states (crystalline, amorphous, and partially amorphous), or multi-states (crystalline, amorphous, and two or more partially amorphous states) depending on how memory 34 is configured. After encoding the data, the data is written to memory 34 through communication link 40.

FIG. 3 is a diagram illustrating one embodiment of reading data from and writing data to memory 34. Memory 34 includes a field emitter 100, an electron collector 200, storage medium 104 having storage areas 106-112, a constant current source 204, read circuit 32, and memory controller 20. Field emitter 100 is proximate storage medium 104 and can be aligned with storage areas 106-112 to provide an electron beam current 206 to a selected storage area 106-112. Read circuit 32 is electrically coupled to electron collector 200 and memory controller 20. Electron collector 200 can also be aligned with storage areas 106-112 to detect, sense, and monitor the magnitude of the signal current associated with a given storage area. In one embodiment, read circuit 32 comprises electron collector 200. Constant current source 204 is electrically coupled to emitter 100 and storage medium 104. Constant current source 204 controls the power density of electron beam current 206.

During a write operation, the structure of a storage area 106-112 is altered in such a way as to vary the storage area's secondary electron emission coefficient (SEEC), the storage area's backscattered electron coefficient (BEC), or the collection efficiency for secondary or backscattered electrons emanating from the storage area. The SEEC is defined as the number of secondary electrons generated from the storage medium 104 for each electron incident onto the surface of the storage medium 104. The BEC is defined as the fraction of the incident electrons that is scattered back from the storage medium 104. The collection efficiency for secondary/backscattered electrons is the fraction of the secondary/backscattered electrons that is collected by electron collector 200, typically registered in the form of a current.

Reading is accomplished by collecting the secondary and/or backscattered electrons when an electron beam with a lower power density is applied to storage medium 104. The collected electrons are then sensed and monitored by read circuit 32. During reading, the power density of electron beam 206 should be kept low enough so that no further writing occurs.

In one embodiment, storage medium 104 is a material whose structural state can be changed from crystalline to amorphous or to partially amorphous by electron beams. An example of this type of material is an alloy based on selenium, tellurium, and indium. The amorphous state has a different SEEC and BEC than a partially amorphous state, which in turn has a different SEEC and BEC than the crystalline state. This leads to a different number of secondary and backscattered electrons being emitted from the storage area. By measuring the number of secondary and backscattered electrons, the state of the storage area can be determined.

To change from the amorphous state or from a partially amorphous state to the crystalline state, the beam power density is increased to a set level and then slowly decreased. This heats up the amorphous or partially amorphous area and then slowly cools it so that the area has time to transform into its crystalline state. To change from the crystalline state to the amorphous state or to a partially amorphous state, the beam power density is increased to a set level and then rapidly decreased. This heats up the crystalline area turning it amorphous and then quickly cools it so that the area does not have time to transform back into its crystalline state.

In the illustrated embodiment, the state of storage area 106 has not been altered, while the states of storage areas 108-112 have been altered to different extents. When electrons bombard a storage area 106-112, both secondary electrons and backscattered electrons are collected by electron collector 200. An area that has been modified produces a different number of secondary electrons and backscattered electrons, as compared to an area that has not been modified and as compared to an area that has been modified to a different extent. The difference can be more or less depending upon the type of material and the type of modification. By sensing and monitoring the magnitude of the signal current collected by electron collector 200 through read circuit 32, the state of, and therefore the value stored in, a storage area 106-112 is identified. The state of storage area 106-112 is communicated to memory controller 20 via output 208 through communication link 40.

The ability to write to and read from more than two states to a storage area allows storage device 30 to store more data in less space than a typical bi-state memory. For example, consider a status flag that can be set to “Off,” “Auto,” or “Manual” in a software application. In a typical bi-state memory, to store this status flag in memory would require at least two storage locations. One storage location indicates whether the flag is set to “Off” while the other storage location indicates whether the flag is set to “Auto” or “Manual.” Storage device 30 requires only one memory location to store the status flag. In one embodiment, the crystalline state can represent “Off,” the amorphous state can represent “Auto,” and the partially amorphous state can represent “Manual.” In this example, storage device 30 reduces the memory locations required to store the status flag by one half. In other examples, the memory locations required to store information can be reduced by two-thirds, three-fourths, four-fifths, etc.

FIG. 4 is a diagram illustrating another embodiment of reading data from memory 34. Memory 34 includes a field emitter 100, storage medium 104 having storage areas 106-112, read circuit 32, and memory controller 20. Field emitter 100 is proximate storage medium 104 and can be aligned with storage areas 106-112 to provide an electron beam current 206 to a selected storage area 106-112. Read circuit 32 is electrically coupled to storage medium 104 and memory controller 20.

In this embodiment, storage medium 104 is based on a diode structure 300, which can be a pn junction, a Schottky barrier, or other type of “electronic valve.” Values are stored by locally altering the surface of a diode in such a way that the collection efficiency for minority carriers generated near the altered region is different from that of an unaltered region. The collection efficiency for minority carriers is defined as the fraction of minority carriers generated by the incident electrons that is swept across diode junction 302 when diode junction 302 is biased by read circuit 32, causing a signal to flow on output 208 in read circuit 32. Read circuit 32 provides a bias across junction 302 and senses the current across junction 302 to provide the signal representing the sensed current on output 208. The signal on output 208, representing the state of the storage area, is communicated to memory controller 20 through communication link 40 and represents the state of and the value stored in a storage area 106-112.

Field emitter 100 emits a narrow beam of electrons onto the surface of diode 300. The incident electrons excite electron-hole pairs near the surface of the diode. The diode is reversed-biased by read circuit 32 such that the minority carriers that are generated by the incident electrons are swept toward diode junction 302. Electrons that reach diode junction 302 will be swept across diode junction 302. Minority carriers that do not recombine with majority carriers before reaching junction 302 are swept across junction 302, causing a current to flow on output 208 in read circuit 32.

Writing onto diode 300 is accomplished by increasing the power density of the electron beam to a set level to locally alter some property of the diode. The amount of the alteration and the state of the memory location is controlled by monitoring the current flowing through the storage medium. The alteration will affect the number of minority carriers swept across junction 302 when the same area is bombarded with a lower power density read electron beam. For example, the recombination rate in a written area 108-112 can be increased relative to unwritten area 106 such that the minority carriers generated in a written area 108-112 have an increased probability of recombining with majority carriers before they have a chance to reach and cross junction 302. Hence, a smaller current flows in read circuit 32 when the read electron beam is incident upon a written area 108-112 than when the read electron beam is incident upon unwritten area 106. Conversely, it is also possible to start with a diode structure having a high recombination rate, and to write values by locally reducing the recombination rate. The magnitude of the current resulting from the minority carriers depends on the state of storage area 106-112; and the current constitutes the signal on output 208 to indicate the value stored.

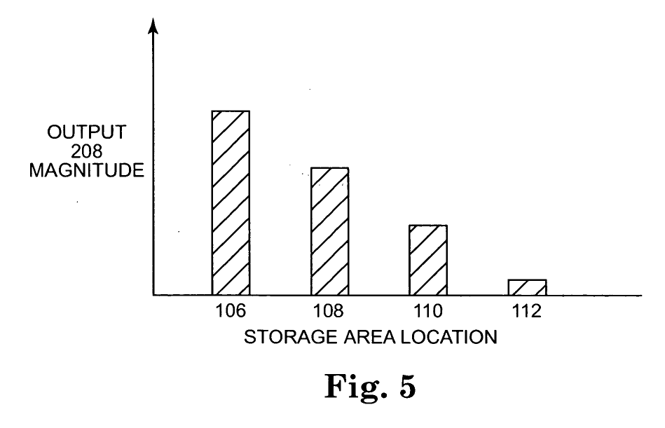

FIG. 5 is a bar chart illustrating the magnitude of output 208 from read circuit 32 for each storage area 106-112 in storage device 30. For storage area 106, which has not been altered by electron bombardment, read circuit 32 senses the largest current from either electron collector 200 for the embodiment of memory 34 illustrated in FIG. 3 or through storage medium 104 for the embodiment of memory 34 illustrated in FIG. 4. For storage area 108, which has been altered by electron bombardment more than storage area 106, read circuit 32 senses a smaller current than the current sensed for storage area 106. For storage area 110, which has been altered by electron bombardment more than storage area 108, read circuit 32 senses a smaller current than the current sensed for storage area 108. For storage area 112, which has been altered by electron bombardment more than storage area 110, read circuit 32 senses a smaller current than the current sensed for storage area 110. The magnitude of the current signal sensed varies from a large value indicating an unaltered storage area to a small value indicating a highly altered storage area.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A storage device comprising:
a field emitter;
a storage medium having a storage area being in one of at least three states to represent information stored at the storage area; and
a read circuit for sensing the state of the storage area and providing an output signal representative of the sensed state.

2. The storage device of claim 1, further comprising:
a controller that receives the read output signal and determines the state of the storage area.

3. The storage device of claim 2, wherein the controller controls the field emitter for reading the state of the storage area.

4. The storage device of claim 2, wherein the controller controls the field emitter for writing the state of the storage area.

5. The storage device of claim 1, wherein the states of the storage area comprise a crystalline state and an amorphous state.

6. The storage device of claim 5, wherein the states of the storage area comprise a partially amorphous state.

7. The storage device of claim 1, wherein the read circuit senses the magnitude of the effect generated when an electron beam current generated by the field emitter bombards the storage area.

8. The storage device of claim 1, wherein the read circuit senses the current generated through the storage area when an electron beam current generated by the field emitter bombards the storage area.

9. A storage device comprising:
a field emitter;
a storage medium having a storage area being in one of at least three states to represent information stored at the storage area;
a read circuit for sensing the state of the storage area and providing an output signal representative of the sensed state;
a controller that receives the output signal and determines the state of the storage area; and
a micromover for moving the field emitter relative to the storage medium.

10. The storage device of claim 9, wherein the controller comprises an encoder configured to encode information for storage in one of the at least three states in the storage area.

11. The storage device of claim 9, wherein the controller comprises a decoder configured to decode information stored in the storage area.

12. The storage device of claim 9, wherein the controller comprises at least a portion of the read circuit.

13. An atomic resolution storage device comprising:
a plurality of field emitters configured to generate electron beam currents;
a storage medium in close proximity to the field emitters, the storage medium comprising a plurality of storage areas being in one of at least three states at or between a crystalline state and an amorphous state to represent information stored in each storage area; and
a read circuit for sensing the state of each storage area and providing an output signal representative of the sensed state.

14. The storage device of claim 13, further comprising:
a controller that controls a power density of the electron beam currents to read and write information at each storage area and that receives the output signal and determines the state of each storage area.

15. The storage device of claim 13, wherein an effect is generated when the electron beam currents bombard the storage areas; the magnitude of the effect depends on the state of each storage area; and the read circuit reads the information stored in each storage area by sensing the magnitude of the effect.

16. The storage device of claim 15, wherein the effect is a current generated through the storage area.

17. The storage device of claim 15, wherein the effect is the emission of secondary electrons and backscattered electrons from the storage area.

18. The storage device of claim 13, further comprising:
an interface configured for moving data between the atomic resolution storage memory and an external device.

19. The storage device of claim 13, wherein the storage medium comprises at least one of selenium, tellurium, and indium.

20. An atomic resolution storage device comprising:
a field emitter configured to generate an electron beam current of varying power density;
a storage medium in close proximity to the field emitter, the storage medium having a storage area; and
a controller adapted to control the field emitter,
wherein the storage area is adapted to being set into any one of at least three states at or between crystalline and amorphous based upon the varying power density of the electron beam current when the electron beam current bombards the storage area.

21. A method for changing the state of an atomic resolution storage memory location, the method comprising:
providing a field emitter;
providing a storage medium in close proximity to the field emitter, the storage medium having a storage area adapted to being in one of at least three states at or between crystalline and amorphous to represent information stored in the storage area;
providing a controller adapted to control the field emitter;
generating an electron beam current of varying power density from the field emitter;
bombarding the storage area with the electron beam; and
sensing the state of the storage area.

22. The method of claim 21, wherein the power density of the electron beam is increased to a set level and then slowly decreased to change the state of the storage area from an amorphous state to a crystalline state.

23. The method of claim 21, wherein the power density of the electron beam is increased to a set level and then rapidly decreased to change the state of the storage area from a crystalline state to one of an amorphous state and a partially amorphous state.
